(19) United States
(12) Patent Application Publication
(10) Pub. No.: US 2026/0148360 A1
(43) Pub. Date: May 28, 2026

(54) SYSTEMS AND METHODS FOR SCORING BONDING OF WIRES TO CATHETER ELEMENTS TO TRAIN AI-BASED OPTICAL INSPECTION MODEL

(71) Applicant: BIOSENSE WEBSTER (ISRAEL) LTD., Yokneam (IL)

(72) Inventors: Assaf Govari, Haifa (IL); Ilya Sitnitsky, Nahariya (IL); Alexander Shechtman, Haifa (IL); Elad Diukman, Haifa (IL); Stas Katzir, Haifa (IL)

(21) Appl. No.: 18/960,309

(22) Filed: Nov. 26, 2024

(51) Int. Cl. G06T 7/00

(52) U.S. Cl. CPC G06T 7/0004; G06T 2200/24; G06T 2207/20081; G06T 2207/20084; G06T 2207/20092; G06T 2207/30141; G06T 2207/30152; G06T 2207/30168

(57) ABSTRACT

A system is provided for evaluating the quality of bonding of wires to catheter elements for training an AI-based optical inspection model. The system includes a display, a user interface device, and a processor, which is configured to (i) present images of the bonds to a user on the display, (ii) receive upon the user interface device scoring information related to the bonding quality based on the presented images, wherein the scoring information comprises an acceptance or rejection of each bond, and (iii) associate the images and scoring information and store the images and scoring information in a memory in a format configured for training an artificial intelligence (AI) based optical inspection model of bonding quality.

### FIELD OF THE DISCLOSURE

The present disclosure generally relates to quality control of the manufacturing of diagnostic and therapeutic catheters, and particularly to quality control of automated bonding of wires to catheter elements.

### BACKGROUND OF THE DISCLOSURE

Certain catheters, such as those involved with cardiac mapping and ablating cardiac tissue, typically have tens of electrodes disposed over flexible splines and electrically connected to a proximal end of the catheter. This large number of electrodes in a small space provides the catheter with precision and accuracy. Some catheters comprise multiple ring-shaped electrodes, each soldered to a wire that may be part of a cable running along the shaft to provide an electrical connection between each electrode and a connector at the proximal end of the catheter. The ring-shaped electrodes may be mounted on one or more splines, forming a distal end assembly of the catheter. Same or other catheters may use flexible printed circuit board (fPCB) to bond the electrodes at one end of the fPCB and wires on another end of the fPCB.

Currently, skilled personnel inspect the soldering quality of the wires to the electrodes manually. The welding quality of wires to fPCB pads is also inspected manually. The small scale of the soldering/welding and the increasing numbers of catheters produced make this process a costly bottleneck quality control step.

The present disclosure will be more fully understood from the following detailed description of the examples thereof, taken together with the drawings.

### BRIEF DESCRIPTION OF THE DRAWINGS

FIG. 1 is a schematic drawing of a sub-system for automated joining of wires to catheter electrodes, in accordance with an example of the present disclosure;

FIGS. 2A and 2B are drawings of GUI tables and menus, the table entries filled in after manual optical inspection with (A) labels of soldering defects of FIG. 2, and (B) gradings of passed soldering, in accordance with an example of the present disclosure;

FIGS. 3A and 3B are schematic drawings of (A) automated welding of wires to catheter flexible PCB pads, and (B) a captured image showing welding defects, in accordance with an example of the present disclosure;

FIG. 4 is a drawing that schematically represents an image of soldering defects that might occur during the automated soldering process shown in FIG. 1, in accordance with an example of the present disclosure; and

FIG. 5 is a flow chart that schematically illustrates a method for labeling bonding (e.g., soldering or welding) defects for training an AI-based optical inspection model, in accordance with an example of the present disclosure.

### DETAILED DESCRIPTION OF EXAMPLES

### Overview

Defects in bonding (e.g., soldering, welding) may occur during an automated bonding process of an array of wires to a respective array of catheter elements (e.g., electrodes, fPCB pads). Some of these defects may cause poor bond quality, shorts or low resistance between neighboring catheter elements, and/or cause mechanical breakdowns under stresses experienced by the catheter.

Many such defects may only be detected at a later stage of catheter manufacturing, or even during use, which causes the rejection of nearly completed catheters or those that have already been sold. To minimize late detection, skilled personnel must manually inspect bonding quality, a process that is a costly and time consuming quality control step.

The present disclosure provides a technique comprising a graphical user interface (GUI) to use operator visual inspections to collect bonding (e.g., soldering, welding) quality data to train an artificial intelligence (AI) based optical inspection model (e.g., a neural network).

The disclose describes a method for training an AI-based optical inspection model for assessing the bonding quality of wires to catheter elements (e.g., pads), the method comprising (i) capturing, by an optical imaging system, a plurality of images of bonding joints between wires and catheter elements automated soldering process using an optical imaging system, (ii) presenting captured images to a user through a GUI, (iii) receive from the user via the GUI scoring information for each bonding wherein the scoring information includes at least whether the bonding passes or fails inspection, (iv) enabling the user to select defect labels from a predefined list when a soldering joint is deemed defective, (v) storing the captured images, user-assigned scores, and selected defect labels in a memory as a training set, and (vi) train the AI-based optical inspection model using the training dataset.

In one example, a system is provided for evaluating the quality of bonding of wires to catheter elements for training an AI-based optical inspection model. The system includes a user interface device, and a processor configured to present images of the bonds to a user on the display. The processor receives upon the user interface device scoring information related to the bonding quality based on the presented images. The scoring information comprises an acceptance or rejection of each bond. The processor associates the images and scoring information and stores the images and scoring information in a memory in a format configured for training artificial intelligence (AI) based optical inspection model of bonding quality.

In an example, the system for real-time assessment of the bonding quality of wires includes (i) a sub-system for automated bonding of the wires, (ii) an optical system configured to capture an image of the bonding and portion of the bonded wires, and (iii) a processor configured to execute the AI-based optical inspection model trained according to the above-described method.

In one example, a camera coupled to a microscope captures the image of a plurality of wires bonded to electrodes. The processor can later display this image to the user, who is prompted, e.g., by a table and menu of a GUI, to score each solder joint.

If the user rejects a bonding joint (i.e., soldering/welding does not pass), the user labels the defect by selecting a defect label from a list. Optionally, if the user accepts a bonding joint, the user grades (e.g., numerically on a scale of 7 to 10) the quality of the passed bonding joint.

The processor stores the user's labeling and the optional grading in memory and later uses it to train the AI-based optical inspection model for automatically detecting faulty bonding joints and, optionally, to classify passed bonding joints into bins.

In another example of the disclosed technique, an array of wires is bonded to catheter pads on an fPCB during an automated bonding process. The camera captures a microscope image of a plurality of bonding joints. Later or while a user is overseeing the automated process, a processor displays the image to the user, who is prompted to score each bonding joint. The user labels the defect by selecting from a list of defect labels. The processor stores the images and the user labeling in memory and uses it at a later date to train the AI-based optical inspection of a bonding model to detect faulty bonding automatically.

The user may also be required to grade (e.g., numerically) the quality of bonds that pass inspection. The processor may use the grading to train the AI-based model to grade passed weld joints automatically.

As the database grows over time (e.g., with an increasing number of filled-out GUI tables) the accuracy of the AI-based bonding quality optical inspection model is expected to improve. The training database can be further expanded and refined by labeling defects detected in the field during catheter use.

AI-based optical inspection model for bonding joint quality, once trained, may be integrated as part of the automated bonding process so that defects automatically identified may be corrected by repeating the joining process, the user may be alerted during the automated joining process and/or the assembly may be tagged as a reject.

### Soldering Sub-System Description

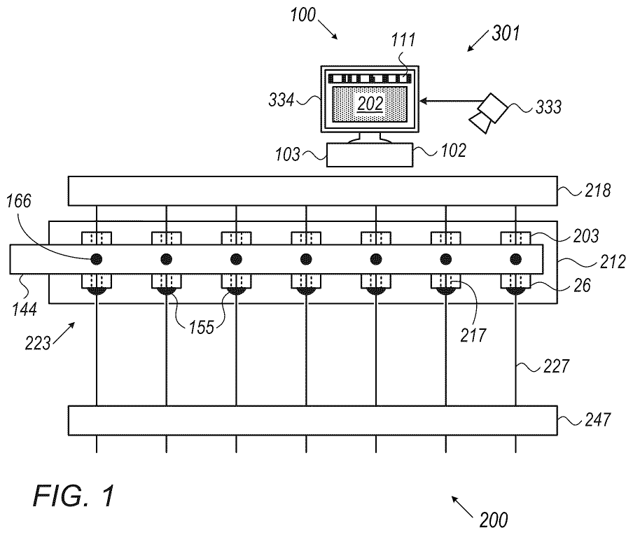

FIG. 1 is a schematic drawing of a sub-system 200 for automated joining of wires 227 to catheter electrodes 26, in accordance with an example of the present disclosure. Electrodes 26 lie in recesses 203 in a tray 212 for the soldering step of electrode-wire assemblies 223. Sub-system's 200 automated joining (or bonding) quality is assessed using system 100.

The electrodes are ring-shaped with a longitudinally extending ring hollow 217. Two wire graspers, 218 and 247, hold the wires 227 that go through hollows 217 under tension between opposite sides of tray 212. Each wire 227 is grasped and pulled from its spool (not shown).

A multi-head soldering iron 144 of a sub-system 200 for automated bonding of the wires 227, soldering iron 144 having soldering heads 166, solders each wire 227 to its respective electrode 26, using tin solder, to create solder joints 155 at each hollow 217 edge to electrically connect the wires to their respective electrodes.

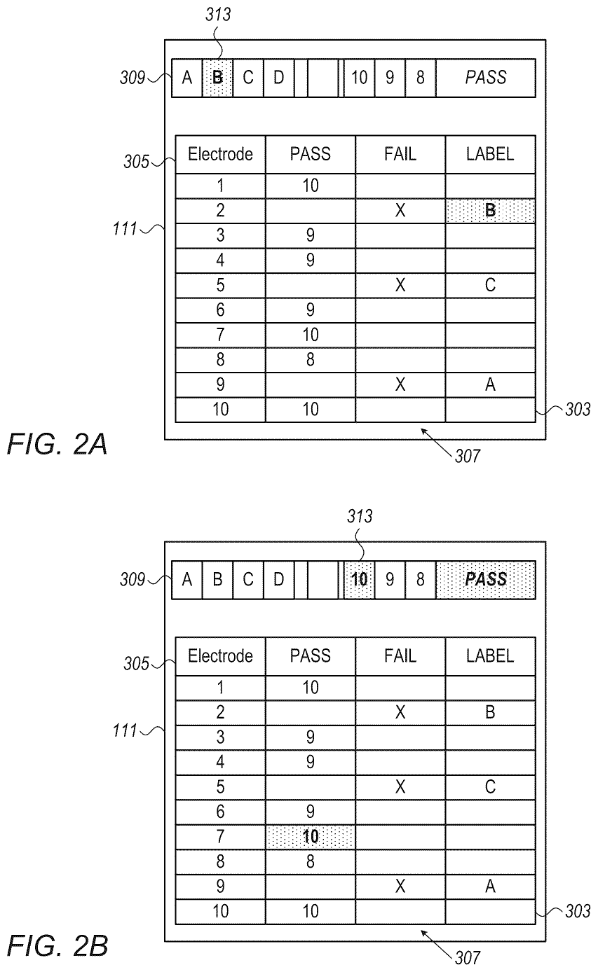

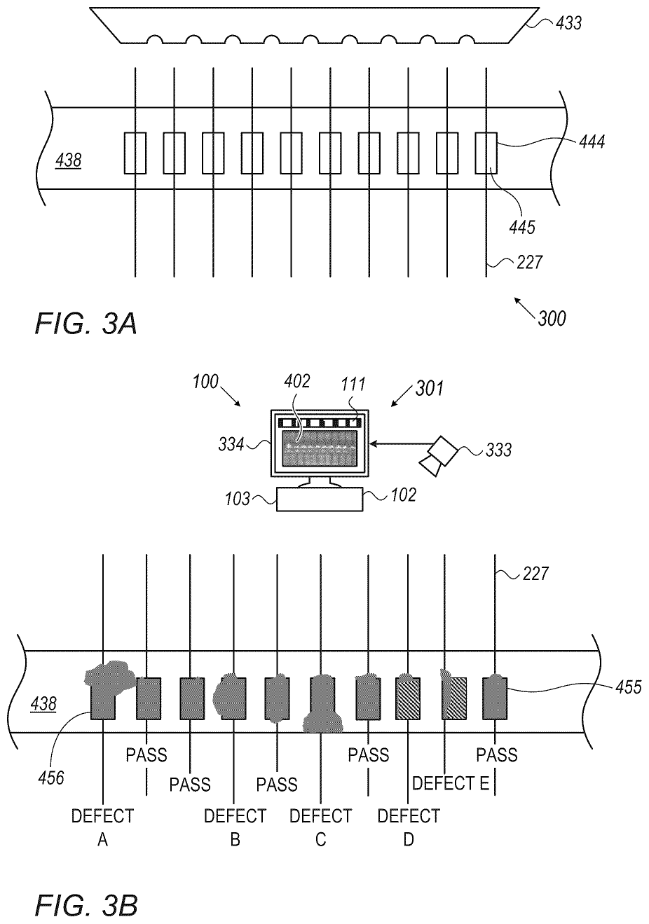

After soldering, tool 144 is removed, and camera 333 (which can be part of an optical inspection sub-system 333) takes image 202 of the wire-electrode solder joints for the purpose of optical inspection by a user to collect training data for an AI-based optical inspection model. The camera may be connected to a microscope with each image 202 displayed on a display device 334 of system 100 for a user to inspect soldering quality. A processor 102 of system 100, having a memory 103, stores image 202 for a later image upload for display. A GUI 111 (e.g., a menu on a touchscreen 334) of system 100 allows the user to score (e.g., grade, label) the soldering, as described in FIGS. 2 and 3.

FIG. 1 is brought by way of example. Details of the soldering, such as a method to supply solder tin, are omitted for clarity.

### GUI for Scoring Soldering of Catheter Electrodes to Train an AI-Based Inspection Model

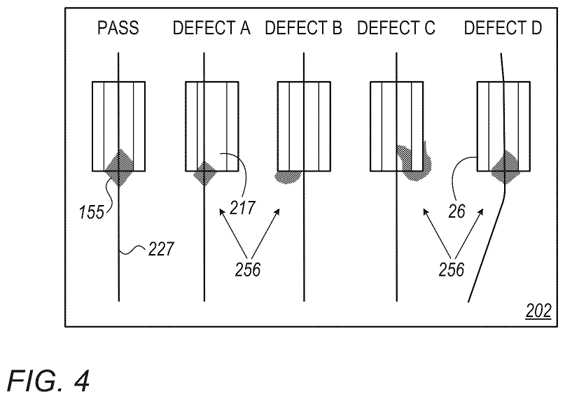

FIGS. 2A and 2B are drawings of GUI 111 tables 303 and menu 309, the table entries 307 filled in after manual optical inspection with (A) labels of soldering defects 256 of FIGS. 3 and 4, and (B) gradings of passed soldering, in accordance with an example of the present disclosure. GUI 111 is part of a user interface device 301.

Menu 309 includes touchscreen buttons 313 of user interface device 301 that allow users to fill in entries 307 according to pass/fail criteria and defect labels. Entries 307 are arranged in columns 305. Entries 307 are also activated by tapping the display.

In the example in FIG. 2A, the user taps an entry 307 in a defect column and then taps a button 313 with a defect label to fill the entry. The tapped entry and button are highlighted to indicate selection.

In the example seen in FIG. 2B, the user taps a pass entry (i.e., in the pass column) and then taps a numeral grading button to fill the pass entry. Again, the tapped entry and button are highlighted to indicate selection.

FIG. 3 is brought by way of example. In another example, the user selects the GUI 111 menu 309 and fills in entries 307 in table 303 by using a keyboard and/or computer mouse.

### Classification of Soldering Defects Using an Image of the FPCB-Wire Soldering

FIGS. 3A and 3B are schematic drawings of (A) automated welding of wires 227 to catheter flexible PCB 438 pads 444, and (B) a captured 402 image showing welding defects 456, in accordance with an example of the present disclosure. Image 402 was taken by camera 333 (which can be part of an optical inspection sub-system 333).

A multi-head welding tool 433 of a sub-system 300 for automated bonding of the wires 227 welds all wires 227 at once to the respective pads 444, which are pre-tinned with bonding material 445, to electrically bond the wires to their respective pads. During welding, the wires are held in tension using graspers (shown in FIG. 1).

In FIG. 3B, with welding tool 433 removed after welding, camera 333 takes image 402 of the wire-pad weld joints for the purpose of optical inspection by a user to collect training data for an AI-based optical inspection model of weld joints. Each image 402 is displayed on display device 334 for a user to inspect welding quality. Processor 102 stores image 402 in memory 103 for later upload and display. A GUI 111 (e.g., a menu on a touchscreen 334) allows the user to score (e.g., grade, label) the weld joints, as described in FIG. 3.

FIG. 3B shows weld joint 455 without defects (i.e., PASS), and weld joints 456 with defects, labelled DEFECT A, DEFECT B, DEFECT C, DEFECT D, and DEFECT E.

DEFECTS A, B, and C are cases where solder paste or tin spread off of the pad after welding, which may cause shorts between pads. DEFECT D shows failed welding with little solder paste holding the wire 227 to pad 444. DEFECT E is a wire displacement with insufficient welding.

### Classification of Soldering Defects Using an Image of the Electrode-Wire Soldering

FIG. 4 is a drawing that schematically represents an image 202 of soldering defects 256 that might occur during the automated soldering process shown in FIG. 1, in accordance with an example of the present disclosure.

Schematically shown image 202 of the plurality of solder joints is captured by camera 333 (e.g., a camera connected to a microscope) and stored by processor 102 in memory 103. The processor may display the stored image to the user on display device 334, or the image 202 may be sent to another location and displayed to a user later.

FIG. 4 shows, left to right, a solder joint 155 without defects (i.e., PASS) and solder joint 256 with various defects, labeled DEFECT A, DEFECT B, DEFECT C, and DEFECT D.

DEFECT A is a wire displaced to one side of the electrode hollow 217. DEFECTS B and C show overflow of the tin outside hollows 217, which may also indicate insufficient soldering. DEFECT D is a wire that curves outside the hollow of the electrode, which may indicate either compromised wire integrity or that the wire was loosened (e.g., from grasper 247) during the soldering process.

The AI-based optical inspection of the soldering model uses a multi-shade or multi-color classification to differentiate the electrodes 26, solder joints 155, and wires 227. In one example, the image shows the electrodes 26 as silver, the solder joints 155 as gray, and the wires 227 as black.

### Method for Scoring Soldering of Catheter Electrodes or Welding of FPCB Pads to Train an AI-Based Inspection Model

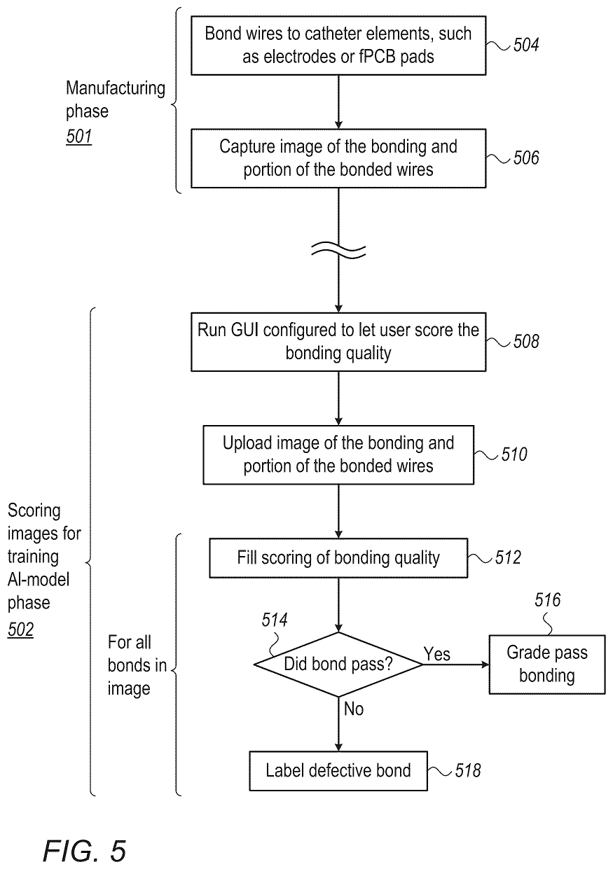

FIG. 5 is a flow chart that schematically illustrates a method for labeling bonding (e.g., soldering or welding) defects for training an AI-based optical inspection model, in accordance with an example of the present disclosure.

A manufacturing phase 501 that precedes the scoring phase includes the wire bonding step 504 described in FIG. 1 or 4, where wires 227 are bonded to catheter elements, such as electrodes 26 or fPCB pads 444.

Afterward, typically in the manufacturing line, an optical system captures an image of the bonding and a portion of the bonded wires 227 around the bond, at an image capturing step 506.

The disclosed phase 502 of scoring the bonding for training an AI-based optical inspection model can be performed offline and at a different location. The disclosed algorithm, according to the presented example, carries out a process that begins at GUI 111 opening step 508.

At GUI opening step 508, the user opens GUI 111 on the processor. GUI 111 comprises a table 303 and a menu 309 to fill the table, such as a menu comprising touchscreen buttons 313 of user interface device 301, as seen in FIG. 3. GUI 111 of user interface device 301 usually comprises an upload button to upload an image to the GUI.

At image uploading step 510, the user uses GUI 111 to upload an image 202 collected at step 502 to present the image on the display device with GUI 111.

Subsequent steps 512-518 are repeated for each bond the user inspects. At a scoring step 512, the user fills a scoring entry 307, which may be an entry of a passed bonding or a failed (e.g., rejected, defected) bond.

If the bond is deemed by the user as defective (514), the user labels the defect at a labeling step 516.

If the bond is deemed by the user as pass (514) (e.g., good enough), the user grades the bonding at a grading step 518. The grade may be numerical or according to list of bins.

The flow chart in FIG. 5 is used as an example. Alternative steps, such saving an image into memory, are omitted for simplicity and clarity.

### EXAMPLES

### Example 1

A system c is provided for evaluating the quality of bonding (155, 455) of wires (227) to catheter elements (26, 444) for training an AI-based optical inspection model. The system includes a display (334), a user interface device (301), and a processor (102), which is configured to (i) present images (202, 402) of the bonds to a user on the display, (ii) receive upon the user interface device (301) scoring information (305, 307) related to the bonding quality based on the presented images (202, 402), wherein the scoring information (305, 307) comprises an acceptance or rejection of each bond, and (iii) associate the images and scoring information and store the images and scoring information in a memory (103) in a format configured for training an artificial intelligence (AI) based optical inspection model of bonding (155, 455) quality.

### Example 2

The system (100) according to claim 1, wherein the bonding (155, 455) comprises one of a soldered joint (155) and a welded joints (455).

### Example 3

The system (100) according to claim 1, wherein the catheter elements are one of electrodes (26), and pads (444) on a flexible PCB (fPCB).

### Example 4

The system (100) according to claim 1, wherein the scoring information (305, 307) further comprises a selection of one or more of a plurality of predefined bond defects (256, 456).

### Example 5

The system (100) according to claim 1, wherein the user interface (301) comprises a touchscreen (334) and the processor (102) is further configured to render a graphical user interface (GUI) (111) upon the display, wherein the GUI (111) presents buttons (313) upon which the user may select scoring information (305, 307).

### Example 6

The system (100) according to claim 1, wherein the user interface (301) is further configured to receive image (202, 402) uploads from the user.

### Example 7

The system (100) according to claim 1, wherein the AI-based model is a neural network (NN) based model.

### Example 8

A method for evaluating quality of bonding of wires (227) to catheter elements (26, 444) for training an AI-based optical inspection model, the method comprising presenting images (202, 402) of the bonds (155, 455) to a user on a display (334). Scoring information (305, 307) related to the bonding (155, 455) quality based on the presented images is received upon a user interface device (111), wherein the scoring information comprises an acceptance or rejection of each bond. The images (202, 402) and scoring information (305, 307) are associated and the images and scoring information are stored in a memory (103) in a format configured for training an artificial intelligence (AI) based optical inspection model of bonding quality.

### Example 9

A method for training an AI-based based optical inspection model for assessing quality of bonding (155, 455) of wires to catheter elements (26, 444), the method comprising capturing, by an optical imaging system (333), a plurality of images (202, 402) of bonding joints between wires and catheter elements automated bonding process using an optical imaging sub-system. The captured images are presented to a user through a graphical user interface (GUI) (111). Scoring information (305, 307) for each bonding is received from the user via the GUI (111), wherein the scoring information includes at least whether the bonding passes or fails inspection. The user is enabled to select defect labels (307) from a predefined list (309) when a soldering joint is deemed defective. The captured images, user-assigned scores, and selected defect labels are stored in a memory (103) as a training set. The AI-based optical inspection model is trained using the training dataset.

### Example 10

A system (100) for real-time assessment of quality of bonding of wires to catheter elements, comprising (i) a sub-system (200, 300) for automated bonding of the wires (227), (ii) an optical system (333) configured to capture an image (202, 402) of the bonding (155, 455) and portion of the bonded wires, and (iii) a processor (102) configured to execute an AI-based optical inspection model trained in accordance with the method of example 9.

Although the examples described herein mainly address cardiac diagnostic applications, the methods and systems described herein can also be used in other medical applications.

It will be appreciated that the examples described above are cited by way of example, and that the present disclosure is not limited to what has been particularly shown and described hereinabove. Rather, the scope of the present disclosure includes both combinations and subcombinations of the various features described hereinabove, as well as variations and modifications thereof which would occur to persons skilled in the art upon reading the foregoing description and which are not disclosed in the prior art.

1. A system for evaluating quality of bonding of wires to catheter elements for training an AI-based optical inspection model, the system comprising:
a display;
a user interface device; and
a processor configured to:
present images of the bonds to a user on the display;
receive upon the user interface device scoring information related to the bonding quality based on the presented images, wherein the scoring information comprises an acceptance or rejection of each bond; and
associate the images and scoring information and store the images and scoring information in a memory in a format configured for training an artificial intelligence (AI) based optical inspection model of bonding quality.

2. The system according to claim 1, wherein the bonding comprises one of a soldered joint and a welded joints.

3. The system according to claim 1, wherein the catheter elements are one of electrodes and pads on a flexible PCB (fPCB).

4. The system according to claim 1, wherein the scoring information further comprises a selection of one or more of a plurality of predefined bond defects.

5. The system according to claim 1, wherein the user interface comprises a touchscreen and the processor is further configured to render a graphical user interface (GUI) upon the display, wherein the GUI presents buttons upon which the user may select scoring information.

6. The system according to claim 1, wherein the user interface is further configured to receive image uploads from the user.

7. The system according to claim 1, wherein the AI-based model is a neural network (NN) based model.

8. A method for evaluating quality of bonding of wires to catheter elements for training an AI-based optical inspection model, the method comprising:
presenting images of the bonds to a user on a display;
receiving upon a user interface device scoring information related to the bonding quality based on the presented images, wherein the scoring information comprises an acceptance or rejection of each bond; and
associating the images and scoring information and storing the images and scoring information in a memory in a format configured for training an artificial intelligence (AI) based optical inspection model of bonding quality.

9. The method according to claim 8, wherein the bonding comprises one of a soldered joint and a welded joints.

10. The method according to claim 8, wherein the catheter elements are one of electrodes and pads on a flexible PCB (fPCB).

11. The method according to claim 8, wherein the scoring information further comprises a selection of one or more of a plurality of predefined bond defects.

12. The method according to claim 8, wherein the user interface comprises a touchscreen and a processor is further configured to render a graphical user interface (GUI) upon the display, wherein the GUI presents buttons upon which the user may select scoring information.

13. The method according to claim 8, wherein the user interface is further configured to receive image uploads from the user.

14. The method according to claim 8, wherein the AI-based model is a neural network (NN) based model.

15. A method for training an AI-based based optical inspection model for assessing quality of bonding of wires to catheter elements, the method comprising:
capturing, by an optical imaging system, a plurality of images of bonding joints between wires and catheter elements automated bonding process using an optical imaging system;
presenting captured images to a user through a graphical user interface (GUI);
receiving from the user via the GUI scoring information for each bonding wherein the scoring information includes at least whether the bonding passes or fails inspection;
enabling the user to select defect labels from a predefined list when a bonding joint is deemed defective;
storing the captured images, user-assigned scores, and selected defect labels in a memory as a training set; and
training the AI-based optical inspection model using the training dataset.

16. A system for real-time assessment of quality of bonding of wires to catheter elements, comprising:
a sub-system for automated bonding of the wires;
an optical system configured to capture an image of the bonding and portion of the bonded wires; and
a processor configured to execute an AI-based optical inspection model trained in accordance with the method of claim 15.
